(19) United States
(12) Patent Application Publication
(10) Pub. No.: US 2015/0026465 A1
(43) Pub. Date: Jan. 22, 2015

(54) Methods And Devices For Protecting Private Data

(71) Applicant: Alcatel Lucent, Paris (FR)

(72) Inventors: Tommaso Cucinotta, Blanchardstown (IE); Alessandra Sala, Dublin (IE)

(73) Assignee: Alcatel Lucent, Paris (FR)

(21) Appl. No.: 13/944,964

(22) Filed: Jul. 18, 2013

(51) Int. Cl. H04L 29/06

(52) U.S. Cl. CPC H04L 63/10; H04L 63/0428
USPC 713/168; 726/4

(57) ABSTRACT

Private data in a cloud-based network may be protected by insuring that inadvertent, malicious, or suspicious access to such data is minimized. Reachability analyses may generate directed graphs that can be displayed as paths on a graphical user interface. If a displayed component of a path indicates that inadvertent, malicious or suspicious access may occur corrective action may be taken to prevent such access.

### BACKGROUND

Existing methods for protecting private data stored within a cloud-based network rely upon complex analysis, or large amounts of computing resources, to identify inadvertent, malicious or suspicious activity.

Accordingly, it is desirable to provide methods and related devices for protecting private data that do not need to rely upon overly complex analyses or large amounts of computing resources.

### SUMMARY

Private data in a cloud-based network may be protected by insuring that inadvertent, malicious, or suspicious access to such data is mitigated. Reachability analyses may generate directed graphs that can be displayed as paths on a graphical user interface. If a displayed component of a path indicates that inadvertent or malicious access may occur, corrective action may be taken to prevent such access.

Exemplary embodiments of methods for protecting private data are provided. For example, in one embodiment, a method for protecting private data (e.g., content, such as video, audio and textual content) may comprise: identifying one or more permissions (e.g., a READ and WRITE operations) associated with private data, a flow of data, or an associated user, application or device; and controlling, through operation of a stored operating system (OS) at a wired or wireless device (local device or network device) within a wired or wireless cloud-based network, a directional flow of data associated with the private data based on the identified permissions. Examples of a local device are a laptop, desktop, tablet, smartphone, or phone, while an example of a network device is a cloud-based server. The OS may be selected from the group consisting of at least a Linux-based OS, a UNIX-based OS, a Microsoft-based OS, and an Apple-based OS, for example.

Controlling access to private data may include granting or denying access to one or more portions of the private data based on identified permissions, and granting or denying access to modify one or more portions of the private data based on identified permissions.

Further, the method may also include controlling, through operation of the OS, a mode of access based on identified permissions. For example, granting or denying access to a function of a device, a process associated with the device or service associated with the device based on identified permissions.

To further protect private data the method may include encryption and decryption. For example, in one embodiment a method may additionally include: (i) encrypting, through operation of the OS, a directional flow of data based on identified permissions; (ii) encrypting, through operation of the OS, substantially all directional flows of data associated with private data using a same encryption key for each flow based on identified permissions; (iii) encrypting, through operation of the OS, one or more directional flows of data associated with private data using a different encryption key for each of the one or more flows based on identified permissions; (iv) decrypting, through operation of the OS, the directional flow of data based on identified permissions; (v) decrypting, through operation of the OS, substantially all directional flows of data associated with private data using a same decryption key for each flow based on identified permissions; (vi) decrypting, through operation of the OS, one or more directional flows of data associated with private data using a different decryption key for each of the one or more flows based on identified permissions.

In addition to associating permissions with private data or a flow of such data, methods are provided for associating permissions to applications, users or devices. For example, in one embodiment a method may comprise: identifying one or more permissions associated with an application (e.g., a content distribution application); and controlling, through operation of the OS, the directional flow of data based on identified permissions associated with the application. The permissions may also be used to control, through operation of an OS, a mode of access. Similar to the methods previously described, the additional methods may also incorporate some form of encryption and decryption. For example, a method may include: (i) encrypting, through operation of the OS, substantially all directional flows of data associated with the application using a same encryption key for each flow based on identified permissions; (ii) encrypting, through operation of the OS, one or more directional flows of data associated with the application using a different encryption key for each of the one or more flows based on identified permissions; (iii) decrypting, through operation of the OS, substantially all directional flows of data associated with the application using a same decryption key for each flow based on identified permissions; and (iv) decrypting, through operation of the OS, one or more directional flows of data associated with the application using a different decryption key for each of the one or more flows based on identified permissions.

To insure that the private data from a device, user or application does not flow to any other device, user or application other than those intended to receive such private data, reachability analyses may be completed. The methods described above and herein may form reachability analyses. In some embodiments, reachability analyses may identify and analyze permissions and other conditions associated with data flows, devices, users or applications in order to insure that inadvertent, malicious, or suspicious access to such data is minimized, or corrective action may be taken to prevent such access.

In conjunction with the methods set forth above (and herein) a reachability analysis may include: specifying a set of rules associated with one or more permissions; reviewing the permissions; and cancelling an attempted action (e.g., installation of a new application, device) based upon a determination that one or more of the rules or permissions has been violated. A particular reachability analysis may be used to generate a so-called “directed graph” based on one or more permissions. A directed graph may represent a flow of data. To aid a user or administrative manager in generating and analyzing directed graphs a user interface (UI) may be provided. In accordance with an embodiment, one or more directed graphs may be generated based on information (rules, etc.,) input through the UI. Thereafter the so generated graphs displayed on a display associated with the UI. To aid a user or administrator even further, one or more portions of a graph may be visually highlighted on the UI. Either through the visual highlighting of a portion of a graph or the like, problems with a component (e.g., potential new permission, rule or condition, new device, application, or flow of data) may be displayed and detected using the UI, and then corrected.

Some embodiments provide related devices for protecting private data. In one embodiment a wired or wireless device within a wired or wireless cloud-based network may be operable to: identify one or more permissions associated with private data (e.g., content, such as video, audio and textual content), a flow of data, a user, an application or a device; and control, through operation of a stored OS, a directional flow of data associated with the private data, a flow of data, or an associated user, application or device based on identified permissions (e.g., a READ and WRITE operations). The device may be a local device or a network device, for example. Similar to the description above, examples of a local device are a laptop, desktop, tablet, smartphone, or phone, while an example of a network device is a cloud-based server. The OS may be selected from the group consisting of at least a Linux-based OS, a UNIX-based OS, a Microsoft-based OS, and an Apple-based OS, for example.

Exemplary devices may control access to private data by granting or denying access to one or more portions of private data based on identified permissions, or granting or denying access to modify one or more portions of the private data based on identified permissions. Such devices, or alternative ones, may also control, through operation of an OS, a mode of access based on identified permissions. In particular, a device may grant or deny access to a function of a device, a process associated with the device or service associated with the device based on identified permissions.

To further protect private data devices may include encryption and decryption functions and features. For example, in one embodiment a device may additionally be operable to: (i) encrypt, through operation of the OS, a directional flow of data based on identified permissions; (ii) encrypt, through operation of an OS, substantially all directional flows of data associated with the private data using a same encryption key for each flow based on identified permissions; (iii) encrypt, through operation of the OS, one or more directional flows of data associated with the private data using a different encryption key for each of the one or more flows based on identified permissions; (iv) decrypt through operation of the OS, the directional flow of data based on identified permissions; (v) decrypt, through operation of the OS, substantially all directional flows of data associated with the private data using a same decryption key for each flow based on identified permissions; and (vi) decrypt, through operation of the OS, one or more directional flows of data associated with the stored data using a different decryption key for each of the one or more flows based on identified permissions.

In addition to providing devices which associate permissions to private data or a flow of such data additional devices which associate permissions to applications, users or devices are provided. For example, in one embodiment a device may be operable to: identify one or more permissions associated with an application (e.g., a content distribution application); and control, through operation of an OS, a directional flow of data based on identified permissions associated with the application. The permissions may also be used to control, through operation of the OS, a mode of access.

Similar to the previously described embodiments, these additional devices may also incorporate some form of encryption and decryption.

The devices described above and herein may be used to complete a reachability analysis. For example, one exemplary device may be operable to: specify a set of rules associated with one or more permissions; review the permissions; and cancel an attempted action (e.g., installation of a new application, device) based upon a determination that one or more of the rules or permissions has been violated. A particular reachability analysis may be used by the device to generate a directed graph.

Additionally, a UI may be provided to aid a user or administrative manager in generating and analyzing directed graphs. In accordance with an embodiment, a device may generate one or more directed graphs based on information (rules, etc.,) input through the UI. Thereafter, the device may be operable to display the so generated graphs on a display associated with the UI. To aid a user or administrator even further, one or more portions of a graph may be visually highlighted on the UI in order to permit a user or administrator, for example, to detect displayed problems with a component, and take corrective action.

Additional features of the present invention will be apparent from the following detailed description and appended drawings.

### BRIEF DESCRIPTION OF THE DRAWINGS

FIG. 1 depicts a simplified block diagram of a network, such as a cloud-based network, according to an embodiment of the invention.

### DETAILED DESCRIPTION, INCLUDING EXAMPLES

Exemplary embodiments of methods and devices for protecting private data are described herein in detail and shown by way of example in the drawing. Throughout the following description and drawing, like reference numbers/characters refer to like elements.

It should be understood that, although specific exemplary embodiments are discussed herein there is no intent to limit the scope of the present invention to such embodiments. To the contrary, it should be understood that the exemplary embodiments discussed herein are for illustrative purposes, and that modified and alternative embodiments may be implemented without departing from the scope of the present invention. Specific structural, functional and methodological details disclosed herein are merely representative for purposes of describing the exemplary embodiments.

It should be noted that some exemplary embodiments are described as processes or methods (collectively “method” or “methods”). Although a method may be described as a series of sequential steps, the steps may be performed in parallel, concurrently or simultaneously. In addition, the order of each step within a method may be re-arranged. A method may be terminated when completed, and may also include additional steps not described herein.

It should be understood that when the terms “identifying”, “controlling”, “determining”, “granting”, “denying”, “encrypting”, and “decrypting” as well as other action, functional or methodological terms and their various tenses are used herein, that such actions, functions or methods may be implemented or completed by one or more processors (collectively referred to as “processor”) operable to execute instructions stored in one or more memories (collectively referred to as “instruction memory”). Such a processor and instruction memory may be a part of a larger device (e.g., network device (server), access device, or local client devices such as laptops, desktops, tablets and smartphones).

As used herein, the term, “or” refers to a non-exclusive or, unless otherwise indicated (e.g., “or else” or “or in the alternative”). It should be understood that when an element is referred to, or described or depicted, as being connected to, or communicating with, another element it may be directly connected to, or in direct communication with, the other element, or intervening elements may be present, unless otherwise specified. Other words used to describe connective or communicative relationships between elements or components should be interpreted in a like fashion. As used herein, the singular forms “a,” “an” and “the” are not intended to include the plural form, unless the context indicates otherwise, or if necessary to preserve the validity of the present application.

As used herein, the term “embodiment” refers to an embodiment of the present invention.

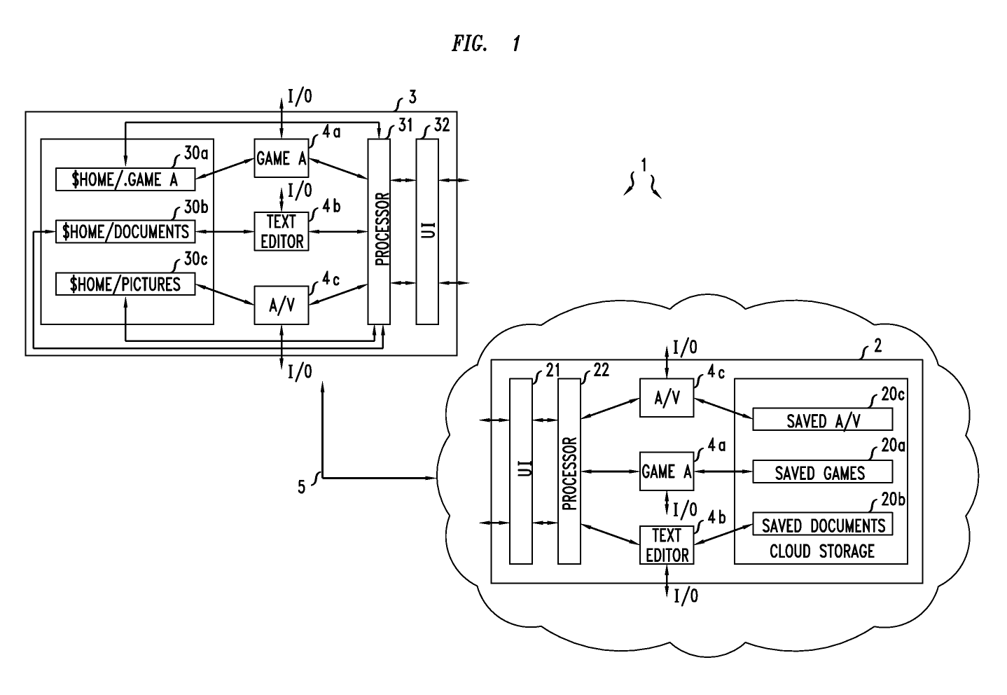

Referring now to FIG. 1 there is depicted a simplified block diagram of a network 1. In an exemplary embodiment, the network 1 may comprise any suitable network such as a cloud-based network. The network 1 may comprise one or more different types of devices, such as devices selected from at least a local device, and a network device, for example. As shown network 1 may comprise network device 2 (e.g., a cloud-based server) communicating over a communications channel 5 with a local device 3 (e.g., laptop, desktop, tablet, smartphone, or phone). Each of the devices shown in FIG. 1 may be wired or wireless devices that may communicate via wired or wireless communication means known in the art. Though only a single network device and local device are shown in FIG. 1 it should be understood that a plurality of each type of device may be included, and connected, within the network 1. Each of the devices shown in FIG. 1 may comprise a processor 21, 31, respectively, operable to execute instructions stored in associated instruction memory to complete functions, features and methods as described herein. For the sake of simplifying the description of the invention the included instruction memory(s) are not shown in FIG. 1. In one embodiment, the processor 31 may be operable to work in conjunction with memory sections 30a, 30b, 30c to store or access data such as document related data, game related data, and image data, respectively to name just some of the many types of data that may be stored within device 3. In addition, processor 31 may be further operable to control one or more stored applications, such as applications stored within game application section 4a, text editor application section 4b, and audio/video (a/v) application section 4c, for example.

Similarly, the processor 21 of network device 2 may be operable to work in conjunction with data memory sections 20a, 20b, 20c and application sections 4a, 4b and 4c. In an embodiment, sections 20a, 20b, 20c may be configured similar to sections 30a, 30b, 30c such that any data that is stored or used by device 3 may be stored and used by device 2 acting on behalf of device 3 and, similarly, any data that is stored or used by device 2 may be stored and used by device 3. As depicted in FIG. 1, sections 4a, 4b, 4c of devices 2, 3 may comprise stored, distributed applications because they are present or distributed within each of the devices 2, 3 for example.

Advantageously, the devices shown in FIG. 1 may be operable to complete innovative functions, features and methods that overcome the limitations of traditional methodologies. In particular, the devices shown in FIG. 1 may be involved in protecting private data (e.g., content, such as video content, audio content, textual content, gaming content etc.,) that may be stored within, or exchanged between, the devices 2,3 shown in FIG. 1, or within or between devices that may be outside the network 1 (i.e., within another network). In slightly more detail, in an embodiment, each of the devices 2,3 may comprise an operating system (OS) that is stored within an instruction memory that may be part of a processor 21,31 or may be stored in a separate memory (not shown). Each OS may be operable to control applications 4a, 4b and 4c, control the flow of data between devices 2,3, and control access to data stored within sections 20a, 20b, 20c, 30a, 30b, and 30c, for example. In alternative embodiments, the OS within device 2 or device 3 may each be selected from the group consisting of at least a Linux-based OS, a UNIX-based OS, a Microsoft-based OS, and an Apple-based OS. It should be understood that the devices 2, 3 comprise all of the necessary electronic components to communicate with one another, including for example input/output (I/O) circuitry. Further, each of the memories and application sections depicted in FIG. 1 also contain the necessary I/O circuitry, etc., to communicate with one another. Because this circuitry is well known it is not shown in FIG. 1.

To illustrate how devices 2, 3 may communicate with one another, assume game application 4a is evoked by a user of the device 3 via user interface (UI) 32 (or by firmware within the device 3 without user intervention, referred to collectively as “firmware”) to store data, related to a recently completed online game, within data memory 30a, and then transfer the stored data to memory 20a within device 2. In some embodiments, the OS within device 3 (or device 2) may be operable to control the storage of the data and its transfer to device 2. The sequence of operations required to store data within memory 30a, and subsequently transfer the data (e.g., a copy) to device 2 may comprise a data “flow”. Further, it may be said that the data flow has a “direction”. In this case, the direction is from the memory 30a within device 3 to the memory 20a within device 2. Data that flows in a direction may be referred to as a directional flow of data. Because data created and stored by, or on behalf of, a user may be considered confidential or unique by the user, the data may be referred to herein as private data. A flow of such data may be referred to as a directional flow of data, or just a flow of data.

In accordance with an embodiment, device 3, and more specifically its OS (for example), may be operable to identify one or more “permissions” associated with private data, or a directional flow of such data, and then control the flow of such data based on the identified permissions. In some embodiments, data that is “associated” with private data may refer to, for example, all of the data stored within a memory (e.g., memory 30a), some of the data stored within a memory, data that is to be stored within a memory, or a directional flow of such data into, and out of, a memory. Permissions may comprise, for example, a set of rules that govern how private data may be created, stored, accessed, exchanged, transferred, encrypted, or decrypted, for example. Permissions may be generated by a user via user interface (UI) 32 (as explained in more detail below), by a network administrator via UI 22, or may be generated by firmware within a memory of devices 2, 3. A permission may also be directed at a user, application, or device. In accordance with an embodiment, an OS may be operable to access an access control model stored in a memory (not shown) in order to identify stored permissions that may exist within the model, where the permissions govern whether or not a user, application or device may (or may not) be granted the right to create, store, access, exchange or transfer private data, for example. In addition, a permission may include authentication and encryption (collectively “encryption”) authorizations and information (e.g., encryption keys, passwords).

Suppose further that an identified, stored permission grants the device 3 permission to transfer private data from memory 30a to memory 20a. In this scenario the OS within device 3 may be operable to control the flow of data such that some, or all, of the private data within memory 30a may be transferred to memory 20a based on the identified permission. In contrast, if an identified permission does not permit such a transfer the OS may be further operable to control the flow of data such that no private data may be transferred, or only a portion of the data may be transferred, for example.

In addition to controlling the flow of data, some embodiments may also be directed at controlling the mode of access to data, data flows or the mode of access to functions, processes or services. Collectively, such access may be referred to as a “mode of access” associated with private data (or an application, user, device). Accordingly, in still further embodiments, the device 3 may be operable to identify one or more permissions, through operation of its OS, that control such a mode of access. More particularly, the device 3 (or user operating the device) may be operable to grant or deny access to a function of the device, a process associated with the device or service associated with the device based on identified permissions.

It should be understood that, as used herein, the meaning of the term “access” differs from the meaning of the term “store” or “transfer” in at least the following manner. Access refers to either: (a) the ability to analyze data that may be already stored in a memory, or, (b) the ability to access the functionality of a device, application, etc. Both READ and WRITE operations are examples of such access. For example, a permission that makes it possible for an application to READ stored videos from an audio/video memory for display is an example of access. Further, a permission that allows an application (or user) to use a web-camera is also granting access to the application (or user). These are just two of the many examples that may be possible, it being understood that controlling access to data as well as controlling access to functions, processes and services associated with an application or device is included within the meaning of the term access. It should be noted that in alternative embodiments an application or user may be granted access to a function, process or service, such as making use of a web based camera to capture images, but, at the same time, may not be granted access to the images that are stored. Thus, access to data and access to functions, processes and services may be separated by a given permission or permissions within an access control model.

In contrast, store or transfer refers to the mere storage or transport, without analysis or further use, of data. Thus, though a permission may grant an application permission to transfer data between files or store data to a memory, the permission may not allow the application to analyze or use the data itself.

Continuing, in an alternative embodiment, device 3 may be operable to identify, through operation of the OS, one or more permissions associated with private data, and then grant or deny access to one or more portions of the private data based on the identified permissions. Yet further, if a user, application or device that has been granted access seeks to additionally modify private data within a memory such actions may be granted or denied based on an identified permission.

In some embodiments, a given user, application or device may be associated with a large number of permissions. When two or more users, applications or devices begin to communicate with one another the number of permissions may increase dramatically. A large number of permissions may result in operations that may allow inadvertent access to private data or to a flow of private data, or worse; the permissions may allow others to maliciously gain access to private data. For example, a user of device 3 may be associated with a permission that allows private data to flow from her device to device 2, but does not allow private data to flow to any other device. However, a user of device 2 may be associated with a permission that allows private data to flow from device 2 to a number of other user devices. To insure that the private data from device 3 does not flow to any other device other than device 2, one or both devices (e.g., processors 21, 31) may be operable to complete reachability analyses that identifies and analyzes permissions and other conditions associated with data flows, devices, users or applications.

In some embodiments, a reachability analysis may make use of “directed graphs”, where a flow of private data may be represented by a directed graph. For example, assuming that game application 4a can access private data within memory 30a, transfer it to memory 20a, and control its storage in memory 20a, a directed graph may be represented as:

(i) memory 30a→application 4a→application 4a→memory 20a.

In some embodiments, the permissions included in a reachability analysis may be generated and input into device 3 by a user via UI 32. For example, a user can specify a set of rules that prescribes permissible reachability conditions (e.g., those files that may, or may not, be accessed, or those documents that may, or may not, be printed) to insure that private data is not inadvertently or maliciously accessed. The device 3 may be operable to review these rules and the associated permissions that are generated each and every time a new application attempts to be installed onto the device 3, or every time modifications are attempted to be done on security settings of applications that have already been stored by the device 3, for example. If it is determined that the attempted installation of a new application or software component, or an attempted change in a security setting or a change to another permission may violate one or more rules or associated permissions (collectively referred to as “attempted action”), then the device 3 (e.g., its processor and OS) may be operable to cancel the attempted action and notify a user by generating and outputting an alarm or warning, for example.

The number and type of permissions may be large and variable. In addition to the permissions described above, another type of permission may include information that: (a) grants a user, application or device access to a given resource (e.g., a phone address book), or a subset of the resource (e.g., a specific phone address book entry, a specific sub-folder within a file-system, a pictures folder, etc. . . . ) through a READ operation; but (b) nonetheless denies the same entity/component the right to WRITE (e.g., upload) to a an external data storage device via the Internet or a cloud storage provider. Another type of permission may include information that governs whether or not a given resource (e.g., memory 30a) may receive data from a particular application that has been granted permission to READ data from the Internet. Still another type of permission may include information that governs whether or not highly sensitive data: (a) may be output from a specific resource (e.g., memory 30a) to another specific resource (e.g., memory 20a), or (b) may be encrypted/decrypted, for example. To elaborate further, in an embodiment when a permission is generated and it includes encryption in one directional flow of data (e.g., input into memory), for example, then the same permission (or a second, linked permission) may also enforce decryption in the return, inverse or opposite direction (e.g., output from memory). In accordance with some embodiments, encryption and decryption may be controlled by the OS, not by an application. Therefore, a given application cannot “work around” or otherwise avoid encryption/decryption.

The directed graph (i) above does not explicitly include or indicate a desire to prevent other users/devices/applications from accessing data transferred to memory 20a from memory 30a. In an embodiment, an additional process of encrypting the private data may be included. An associated directed graph that includes encryption may be represented as follows:

(ii) memory 30a→E→application 4a×application 4a→memory 20a,

where the notation “E” indicates that the private data from memory 30a was encrypted prior to being transferred to application 4a. Once again, this helps to illustrate embodiments where an OS, not an application, controls encryption (as well as decryption). Once encrypted, access to the transferred private data is typically only possible through decryption (as explained in more detail below) thus insuring that a transfer of data from memory 20a to another user, device, etc., may not result in access to such data. The generation and display of directed graphs may assist a user in detecting operations that might otherwise lead to inadvertent or malicious access to private data. It should be noted that the directed graphs described above are just two of the many graphs that may be generated and displayed in some embodiments.

As noted previously, permissions may comprise READ or WRITE operations. A READ or WRITE permission may be associated with, and directed at, local resources, such as memory 30a, a local file-system and local databases. Still further, remotely located resources, including the Internet itself, may be associated with a given permission. An exemplary permission may allow for reading pages from the Internet, but not for submitting data to (a) web systems, or (b) to an external cloud storage provider, or (c) to other types of external data storage systems, such as FTP servers, content management systems, etc.

As briefly described above, some embodiments provide for the encryption of data flows. In particular, a permission may include encryption/decryption information. Thus, in one embodiment the device 3 may be operable, through operation of its OS, to encrypt one or more directional flows of data based on identified permissions that contain encryption information. As noted above, it is the OS that controls encryption/decryption (through the generation of permissions. Placing the function of controlling the encryption (and decryption) of private data with the OS, instead of an application, provides a level of insurance against inadvertent access. Said another way, if the provider of the application does not include an encryption function into the application to encrypt private data this omission may not lead to access to the data because the OS may encrypt the data in any event in accordance with permissions mandated by a stored access control model, for example.

In some embodiments, access to an encryption key, and its use, may be limited. For example, the device 3 may be operable to limit access to an encryption key such that the key is only accessible and usable when dealing with a specific data flow, a specific user, a specific application or a specific device. In an embodiment, limiting access to a key may be controlled by the device's OS. Alternatively, the device 3 may comprise special tamper-proof components such as trusted platform module (TPM) chips or a smart-card. Still further, the OS may control the use of secure protocols that may be used when an encryption key is exchanged between devices (e.g., in those cases where a user may access his/her data or services from multiple devices).

The use of an encryption key to encrypt private data is one encryption method. When such a method is used a related, decryption key may also be used to decrypt the encrypted data. It should be understood that many types of encryption and decryption keys may be used including symmetric encryption keys (i.e., the same key is used for encryption and decryption) or asymmetric encryption keys (i.e., a pair of keys are used where both an encryption key and decryption key may be generated together). Further the length of a key may vary based on the degree of encryption desired (e.g., weak to strong). In some embodiments, a key may be stored in memory, within a file-system, within a special component within a device such as a TPM chip, or within an external device such as a smart-card. A key may be stored in plain-text form or in encrypted form. A key may be encrypted using a further key generated from a user passphrase, for example. It should be understood that the methods and means for generating encrypted keys are many, and, therefore, any number of such means and methods may be used to generate, store and manage keys including the use of Public Key Infrastructures (PKIs), or key escrow mechanisms, for example.

Relatedly, substantially all directional flows of data associated with private data may be encrypted (and decrypted) using a same encryption key for each flow in accordance with identified permissions. Alternatively, one or more directional flows of data associated with private data may be encrypted (and decrypted) using a different encryption key for each of the one or more flows based on identified permissions. For example, if the device 3 (e.g., its OS) encrypts data from memory 30a using a particular key then the device 2 may decrypt the data using a related key and then store the decrypted data within memory 20a, for example. The reverse is possible as well (i.e., device 2 encrypts and device 3 decrypts).

As mentioned above, in addition to associating permissions to a flow of data, permissions may also be associated with a user, application or device though many times the flow may inherently involve a user, application or device. Accordingly, in still further embodiments, the device 3 (for example) may be operable to identify one or more permissions associated with an application, such as game application 4a (e.g., a content distribution application), and then control, through operation of its OS, a directional flow of data or a mode of access based on the identified permissions associated with the application 4a. As before, a permission may include encryption/decryption information. Accordingly, in further embodiments, the device 3 may be further operable to: (i) encrypt, through operation of its OS, substantially all directional flows of data associated with an application, such as application 4a (e.g., flows between device 3 and device 2) using a same encryption key for each flow based on the identified permissions; (ii) encrypt, through operation of its OS, one or more directional flows of data associated with the application using a different encryption key for each of the one or more flows based on the identified permissions; (iii) decrypt, through operation of its OS, substantially all directional flows of data associated with the application using a same decryption key for each flow based on the identified permissions; or (iv) decrypt, through operation of the OS, one or more directional flows of data associated with the application using a different decryption key for each of the one or more flows based on the identified permissions.

FIG. 1 depicts UIs 22 and 32, respectively. The UIs may be used to complete a number of different features, functions and methods related to reachability analyses. Each of the UIs 22, 32 may comprise a display that functions as a graphical user interface (GUI), for example. In an embodiment, a user of device 3 may add, delete or modify permissions using UI 32. These permissions may be stored in a memory within device 3. Upon receipt of permission-related information (including rules, conditions) from the user via UI 32, the device 3, and in particular, processor 31 and its associated OS may be operable to generate one or more associated directed graphs based on the information. Once the graphs are generated the device 3 may be further operable to display the so-generated directed graphs on a display that is part of the UI 32, for example. As before the permissions may be associated with a flow of data, one or more users, one or more applications, one or more devices, or a combination of these parameters. By displaying a directed graph to a user via a GUI, the user may be able to quickly identify data flows that are problematic; that is, those that may lead to inadvertent access to private data or to a flow of private data, for example.

The directed graphs (i) and (ii) set forth above are just two of the many types of graphs that may be generated. In addition to displaying the graphs, GUIs may also be operable to visually highlight or otherwise use a noticeable font or another indicator to make it easier for a user (or the device) to notice or detect a portion of the graph, such as those portions related to encryption, for example. Similarly, GUIs may be operable to indicate connections between two portions of a graph using a number of symbols such as the symbol “→” used in graphs (i) and (ii). Still further the GUIs may display a portion or connection in one or more different colors to distinguish one portion or connection from another, for example (collectively, the above description may be referred to as “visually highlighting” a portion of a graph).

The so-generated directed graphs may be used to determine potential reachability “paths”. That is, the device 3 may be operable to receive potential starting or source points (e.g., memory 30a), along with intermediate points (e.g., memory 20a) and destination points (e.g., another node within the network 1) in addition to permissions associated with such points and then generate and display a path as a directed graph that represents a flow (or not) of private data from the source, to the intermediate point, to the destination point, for example. The display of potential paths on GUIs 22, 32 may assist a user or administrative manager in visualizing or otherwise determining those paths which may lead to access, either intentional or inadvertent, to private data or to a flow of private data, or in visualizing or determining a violation of a pre-existing condition (i.e., permissions).

Additional examples may help in illustrating the usefulness of the GUIs 22,32. A user may input information or otherwise configure device 3 (e.g., its OS) to generate a permission or condition that allows private data from memory 30a to be encrypted and then sent to a device operated by an external cloud provider, such as device 2, so that the cloud provider can provide an effective data backup service for the user's data stored within memory 30a. In this example, however, the permission or condition may not permit the cloud provider to access the private data (i.e., the data cannot be decrypted by the provider). Instead, the data is simply stored in memory 20a, for example. In another example, the user may input or otherwise configure the device 3 to generate a permission or condition that prohibits or denies any request to send private data from the memory 30a to any other user, application or device, even if the data has been encrypted.

At some point in time there may exist previously generated directed graphs. Accordingly, methods and devices for analyzing these graphs are provided. For example, a user may be operable to operate GUI 32 in order to display one or more existing graphs on a display that is part of the GUI. While the existing graphs are displayed the user may be able to visualize the effect that a potential new permission or condition may have on an existing graph and the data flows, users, devices, and applications associated with portions of the graph. A user may troubleshoot indicated problems by displaying a particular graph on the UI 32. Once displayed the user may be able to visualize the paths, and the data flows, users, devices, and applications associated with the path (collectively, referred to as “components” of a path or graph) on the GUI 32. In an embodiment the display of a graph may aid the user in detecting whether one of the components may be the source of a problem. If a problematic component is identified as a source of the problem then the device 3, upon receiving input from a user via GUI 32 (or by itself, through firmware or the like) may be operable to take corrective action by, for example, uninstalling a problematic component (e.g., application), disconnecting a problematic component (e.g., user or device) or quarantining a problematic component (e.g., a file) to name just a few of the many types of corrective action that may be initiated and completed by the user or device 3 and its GUI 32 to prevent inadvertent or malicious access to private data or to a flow of private data.

While exemplary embodiments have been shown and described herein, it should be understood that variations of the disclosed embodiments may be made without departing from the spirit and scope of the invention. For example, variations on the reachability analyses described herein, that include additional permissions, directed graphs and paths other than those described herein or in conjunction with those described herein, may be implemented within the scope of the invention, and may be encompassed by the claims that follow.

What is claimed is:

1. A method for protecting private data comprising:
identifying one or more permissions associated with private data; and
controlling, through operation of a stored operating system (OS) at a device within a cloud-based network, a directional flow of data associated with the private data based on the identified permissions.

2. The method as in claim 1 further comprising:
controlling, through operation of the OS, a mode of access based on the identified permissions.

3. The method as in claim 2, further comprising granting or denying access to a function of the device, a process associated with the device or service associated with the device based on the identified permissions.

4. The method as in claim 1, further comprising granting or denying access to one or more portions of the private data based on the identified permissions.

5. The method as in claim 1, further comprising granting or denying access to modify the one or more portions of the private data based on the identified permissions.

6. The method as in claim 1 further comprising encrypting, through operation of the OS, the directional flow of data based on the identified permissions.

7. The method as in claim 1 further comprising encrypting, through operation of the OS, substantially all directional flows of data associated with the private data using a same encryption key for each flow based on the identified permissions.

8. The method as in claim 1 further comprising encrypting, through operation of the OS, one or more directional flows of data associated with the private data using a different encryption key for each of the one or more flows based on the identified permissions.

9. The method as in claim 1 further comprising decrypting, through operation of the OS, the directional flow of data based on the identified permissions.

10. The method as in claim 1 further comprising decrypting, through operation of the OS, substantially all directional flows of data associated with the private data using a same decryption key for each flow based on the identified permissions.

11. The method as in claim 1 further comprising decrypting, through operation of the OS, one or more directional flows of data associated with the private data using a different decryption key for each of the one or more flows based on the identified permissions.

12. The method as in claim 1, wherein the OS comprises an operating system selected from the group consisting of at least a Linux-based OS, a UNIX-based OS, a Microsoft-based OS, and an Apple-based OS.

13. The method as in claim 1, wherein the the data comprises content.

14. The method as in claim 1 further comprising:
identifying one or more permissions associated with an application; and
controlling, through operation of the OS, the directional flow of data based on the identified permissions associated with the application.

15. The method as in claim 14, wherein the application comprises a content distribution application.

16. The method as in claim 1 further comprising:
identifying one or more permissions associated with an application; and
controlling, through operation of the OS, a mode of access based on the identified permissions associated with the application.

17. The method as in claim 14 further comprising encrypting, through operation of the OS, substantially all directional flows of data associated with the application using a same encryption key for each flow based on the identified permissions.

18. The method as in claim 14 further comprising encrypting, through operation of the OS, one or more directional flows of data associated with the application using a different encryption key for each of the one or more flows based on the identified permissions.

19. The method as in claim 14 further comprising decrypting, through operation of the OS, substantially all directional flows of data associated with the application using a same decryption key for each flow based on the identified permissions.

20. The method as in claim 14 further comprising decrypting, through operation of the OS, one or more directional flows of data associated with the application using a different decryption key for each of the one or more flows based on the identified permissions.

21. The method as in claim 1, wherein the device comprises a wireless device.

22. The method as in claim 1 further comprising:
specifying a set of rules associated with one or more permissions;
reviewing the permissions; and
cancelling an attempted action based upon a determination that one or more of the rules or permissions has been violated.

23. The method as in claim 1, wherein the permission comprises a READ or WRITE operation.

24. The method as in claim 1 further comprising generating one or more directed graphs based on information input through a user interface (UI).

25. The method as in claim 24 further comprising displaying the one or more directed graphs on a display of the UI.

26. The method as in claim 24 further comprising visually highlighting a portion of a graph on the UI.

27. The method as in claim 1, wherein the permissions are associated with a flow of data, a user, an application or a device.

28. The method as in claim 24 further comprising:
displaying a problem with a component of the graph using the UI; and
correcting the problem.

29. A device within a cloud-based network for protecting private data operable to:
identify one or more permissions associated with private data; and
control, through operation of a stored operating system (OS), a directional flow of data associated with the private data based on the identified permissions.

30. The device as in claim 29 further operable to:
control, through operation of the OS, a mode of access based on the identified permissions.

31. The device as in claim 30 further operable to grant or deny access to a function of the device, a process associated with the device or service associated with the device based on the identified permissions.

32. The device as in claim 29 further operable to grant or deny access to one or more portions of the private data based on the identified permissions.

33. The device as in claim 29 further operable to grant or deny access to modify the one or more portions of the private data based on the identified permissions.

34. The device as in claim 29 further operable to encrypt, through operation of the OS, the directional flow of data based on the identified permissions.

35. The device as in claim 29 further operable to encrypt, through operation of the OS, substantially all directional flows of data associated with the private data using a same encryption key for each flow based on the identified permissions.

36. The device as in claim 29 further operable to encrypt, through operation of the OS, one or more directional flows of data associated with the private data using a different encryption key for each of the one or more flows based on the identified permissions.

37. The device as in claim 29 further operable to decrypt, through operation of the OS, the directional flow of data based on the identified permissions.

38. The device as in claim 29 further operable to decrypt, through operation of the OS, substantially all directional flows of data associated with the private data using a same decryption key for each flow based on the identified permissions.

39. The device as in claim 29 further operable decrypt, through operation of the OS, one or more directional flows of data associated with the private data using a different decryption key for each of the one or more flows based on the identified permissions.

40. The device as in claim 29, wherein the OS comprises an operating system selected from the group consisting of at least a Linux-based OS, a UNIX-based OS, a Microsoft-based OS, and an Apple-based OS.

41. The device as in claim 29, wherein the the data comprises content.

42. The device as in claim 29 further operable to:
identify one or more permissions associated with an application; and
control, through operation of the OS, the directional flow of data based on the identified permissions associated with the application.

43. The device as in claim 42, wherein the application comprises a content distribution application.

44. The device as in claim 29 further operable to:
identify one or more permissions associated with an application; and
control, through operation of the OS, a mode of access based on the identified permissions associated with the application.

45. The device as in claim 42 further operable to encrypt, through operation of the OS, substantially all directional flows of data associated with the application using a same encryption key for each flow based on the identified permissions.

46. The device as in claim 42 further operable to encrypt, through operation of the OS, one or more directional flows of data associated with the application using a different encryption key for each of the one or more flows based on the identified permissions.

47. The device as in claim 42 further operable to decrypt, through operation of the OS, substantially all directional flows of data associated with the application using a same decryption key for each flow based on the identified permissions.

48. The device as in claim 42 further operable to decrypt, through operation of the OS, one or more directional flows of data associated with the application using a different decryption key for each of the one or more flows based on the identified permissions.

49. The device as in claim 29, wherein the device comprises a wireless device.

50. The device as in claim 29, wherein the device comprises a local device.

51. The device as in claim 50, wherein the local device comprises a laptop, desktop, tablet, smartphone, or phone.

52. The device as in claim 29, wherein the device comprises a network device.

53. The device as in claim 52, wherein the network device comprises a server.

54. The device as in claim 29 further operable to:
specify a set of rules associated with one or more permissions;
review the permissions; and
cancel an attempted action based upon a determination that one or more of the rules or permissions has been violated.

55. The device as in claim 29, wherein the permission comprises a READ or WRITE operation.

56. The device as in claim 29, further comprising a user interface (UI) operable to input information into the device, and the device further operable to generate one or more directed graphs based on the information input through the UI.

57. The device as in claim 56, wherein the UI comprises a display, and the UI is further operable to display the one or more directed graphs on the display.

58. The device as in claim 57, wherein the UI is further operable to visually highlight a portion of a graph on the display.

59. The device as in claim 29 wherein the permissions are associated with a flow of data, a user, an application or a device.

60. The device as in claim 57, wherein the device is further operable to:
display a problem with a component of the graph using the UI; and
correct the problem.
